(19) United States
(12) Patent Application Publication
(10) Pub. No.: US 2008/0132278 A1
(43) Pub. Date: Jun. 5, 2008

(54) Cell phone communication system locking cradle

(76) Inventor: Jack Howard Dovey, Federal Way, WA (US)

Correspondence Address: LAW OFFICE OF POLLY L. OLIVER, 3134 Parkside Circle NE, Tacoma, WA, 98422, US

(21) Appl. No.: 11/982,521

(22) Filed: Nov. 1, 2007

Related U.S. Application Data
(60) Provisional application No. 60/856,552, filed on Nov. 2, 2006.

(51) Int. Cl. H04M 1/00

(52) U.S. Cl. 455/557

(57) ABSTRACT

The Locking Communication Cradle is a durable, waterproof, and dent-resistant container (typically of two-piece molded plastic construction) for a cell phone, GPS unit, speaker, battery, and/or other communication tool or piece of equipment which may be components of a larger communication system. The Locking Communication Cradle may be wall- or pedestal-mounted in a building, or installed in a truck, boat, or other vehicle, and is designed to hold the system components securely in position, while making them accessible only in part to the local users—according to a predetermined use. These specially designed containers, which may come in several designs to accommodate different configurations of system components, are intended to limit the local manipulation of the units so that the fleet manager, school principal, or other controller can rely on the integrity of the data being transmitted and received.

### RELATED APPLICATIONS

This application is related to and claims priority under 35 U.S.C. 119(e) to U.S. provisional application Ser. No. 60/856,552, entitled “GPS Tracking System,” filed on Nov. 2, 2006, by inventor Jack Dovey, which is hereby incorporated by reference in its entirety.

### FIELD OF THE INVENTION

This invention pertains generally to functional containers and more particularly to a specially-designed locker for containing a GPA unit and/or cell phone as well as other components of the local unit of a larger communication system.

### BACKGROUND OF THE FIELD

Cell phones are used to transmit and receive voice transmissions used to communicate between users of these units. Typically, the users can manipulate their cell phones by turning them on and off, adjusting the volume, letting the battery run down, ignoring calls, etc. When the cell phone is used mainly as a receiver for a local unit of a larger system, it may not be desirable for the local unit user to have such wide manipulative control over the unit. In other words, the main base operator of the communication base unit may have an interest in his message being transmitted and received regardless. In this case, it is necessary to have the local units housed in a locked container that cannot be opened by the local user. In addition, it may be necessary for the container to cover certain buttons or other controls on the cell phone (or GPS or other unit) to limit the local user's manipulation of such device.

Prior patents have disclosed functional containers, such as the U.S. Pat. No. 7,187,944 to Liao which discloses an automatic cell phone dialing device. Liao's device holds a cell phone in a casing typically mounted inside a car that includes a “dialing finger” for automatically dialing a specified number in case of emergency. Although the cell phone is a communication tool and can be said to be part of a larger network, the casing is not intended and does not prevent the local user from accessing certain buttons or other cell phone controls.

US Patent Application Publication No. 2003/0064702 to Van Egmond et al. discloses a container for computer network components. However, Van Egmond's device is not intended to provide the local user any access at all, let alone limit that access. There are no windows on the housing, because the components housed therein are not intended for voice communication use by a local user.

U.S. Pat. No. 6,278,059 to Lefton discloses a container for electronics having two portions that fit together. The front, generally planar, panel defines apertures necessary to the components inside. However, in this case, the apertures do not provide access but are intended to provide for airflow only, and the front cover itself is removable, not lockable to limit user access.

In US Patent Application Publication No. 2006/0060578, Church et al. disclose a locking container. However, the container is not meant for and does not house a cell phone or any other communication device. Instead, the container is used in stores with items to sell and is intended to prevent shoplifting. The access through the front panel allows a person to remove an item from the interior and separate it from the container in order to purchase it. In addition, Church's device is not part of a larger networked system.

### SUMMARY OF THE INVENTION

The present invention solves the above-mentioned problems by providing a simple functional container that can limit the local user's manipulation of the communications tool secured therein (e.g., cell phone, GPS unit, radiotelephone, or other local device) in a larger communication system. The larger communication system typically includes a base transmitting device for sending out voice signals to several local receiving devices. Cell phones are typically used as the communication tools within these devices. Any other communication tool could be used that has receiving functionality and therefore would be useful in the larger communication system.

The functional container herein may comprise two mating portions which nest together at a mating perimeter edge and can be locked so as to prevent opening by the local user. The container may be adapted to sit on a generally horizontal surface or to mount on a vertical surface. Either way, the container is preferably made from shock-resistant, heat-resistant, durable, molded plastic, and the second (bottom) portion may be designed to hold the various components securely therein. The first (top) portion defines at least one window revealing the LCD or other desired area on the communication tool therein, e.g., cell phone, GPS unit, radiotelephone, or other communication device. The first portion also defines at least one tab protruding into the window so as to cover at least one of the operative buttons on the communications tool—such as an on/off switch, a volume control, an ignore button, etc.—in order to limit the manipulation thereof by a local user. With this functional container (commonly called a locking cradle or a communications cradle or some other descriptive term), the local units of a larger communications network can be configured to some predetermined use by the base unit—typically a transmitter unit connected to each local unit.

### BRIEF DESCRIPTION OF THE DRAWINGS

The objects, features, and advantages of the present invention will be apparent to one skilled in the art from reading the following description in which:

FIG. 1 is a perspective view of a preferred embodiment of the functional container locking cradle with window and tab as it is used to securely house a local unit (here a cell phone) of a larger communication system;

FIG. 2 is a detail perspective view of the inside of the bottom portion of FIG. 1 showing how it holds the various components; and

FIG. 3 is a block diagram showing a possible configuration of a larger communication system comprising several local units housed securely in the locking cradle.

### DETAILED DESCRIPTION

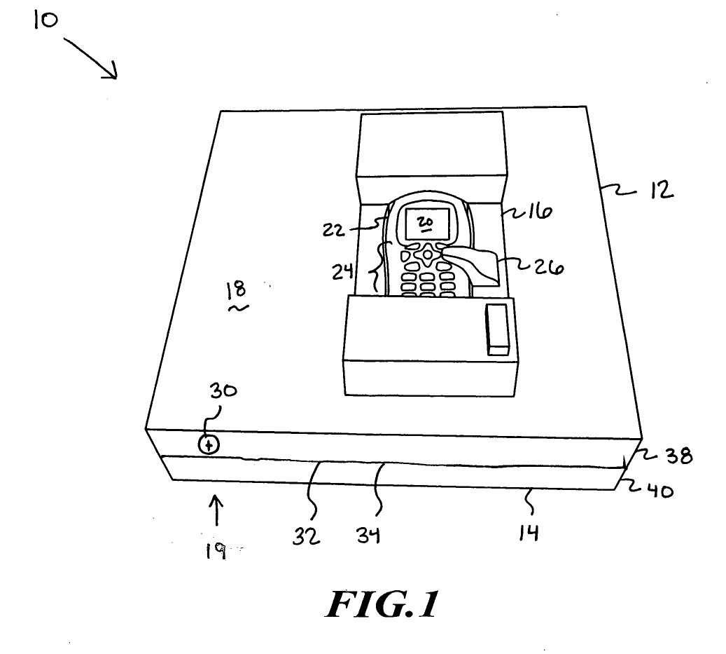

FIG. 1 shows how the locking cradle container (or communication cradle) 10 has a first (top) portion 12 and a second (bottom) portion 14. The window 16 in the generally planar front panel 18 of the first portion 12 reveals the viewing area 20 of the cell phone 22 (or other communication tool) as well as several operative buttons 24 on the front face of the cell phone. The tab 26 protrudes into the window 16 and is strategically located to cover the on/off control 28 (not shown) of the cell phone, so that a local user can receive incoming messages and dial out if necessary, but not turn the phone off. In alternate embodiments, there may be several tabs protruding into the window and covering several operative controls (such as volume controls, ignore buttons, etc.) to prevent the use thereof. The phone can only be turned off from inside the locking cradle container 10, and the container is locked with a locking mechanism defined by locking means 30 (which may be a conventional key-operated lock or any other appropriate type of lock) so that the local user cannot get inside the container. In this way, the communication cradle may be used to provide system functionality to the larger communication system according to a predetermined use.

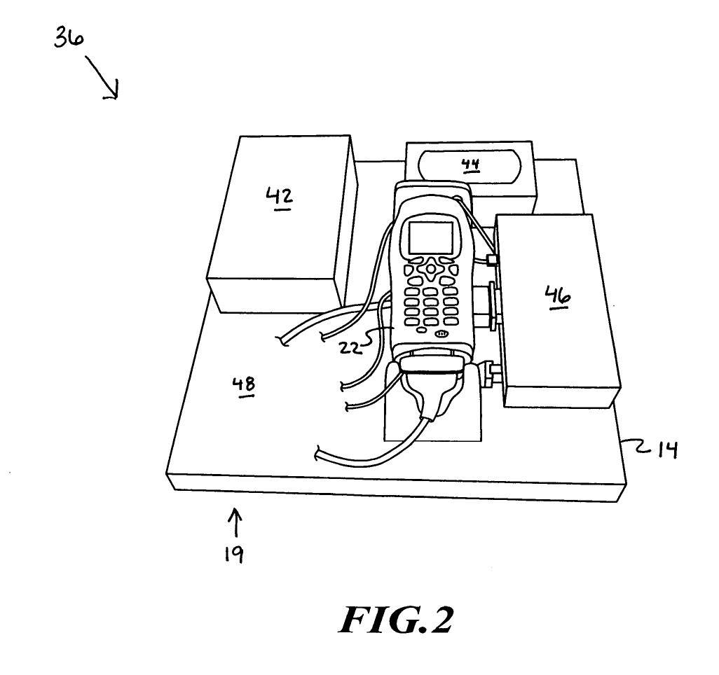

The first portion 12 and the second complementary portion 14 are designed to nest together along their respective perimeter edges 32 and 34 and to form a closed container and thereby an interior cavity 36 (shown in FIG. 2). The front panel 18 is typically generally planar and separated from the perimeter edge 32 by connecting walls 38. The back generally planar panel 19 is typically generally planar and separated from the perimeter edge 34 by connecting walls 40. The back panel 19 further may be adapted to hang on a vertical surface such as a wall. Both portions 12 and 14 are capable of being locked together by locking means 30, so that they can only be unlocked by a superior personnel—usually the principal, administrator, or fleet captain—and not the local user.

FIG. 2 shows the locking cradle 10 with first portion 12 removed. The second portion 14 is designed to securely hold the various necessary components therein. In addition to the cell phone 22 or other communication tool such as a GPS unit or radiotelephone, there may be an amplifier unit 42, a speaker unit 44, and/or a battery backup unit 46. The components may be powered by a cable plugged into an electric wall outlet (not shown) unless and until the battery backup is needed. All the necessary cables and wires may be gathered and coiled in one area 48 of the second portion 14. Although the bottom portion 14 may be formed to hold these various components within the container 10, the exterior of the back panel 19 will be generally planar so that it may be attached to a wall or set upon a generally horizontal surface such as a desk.

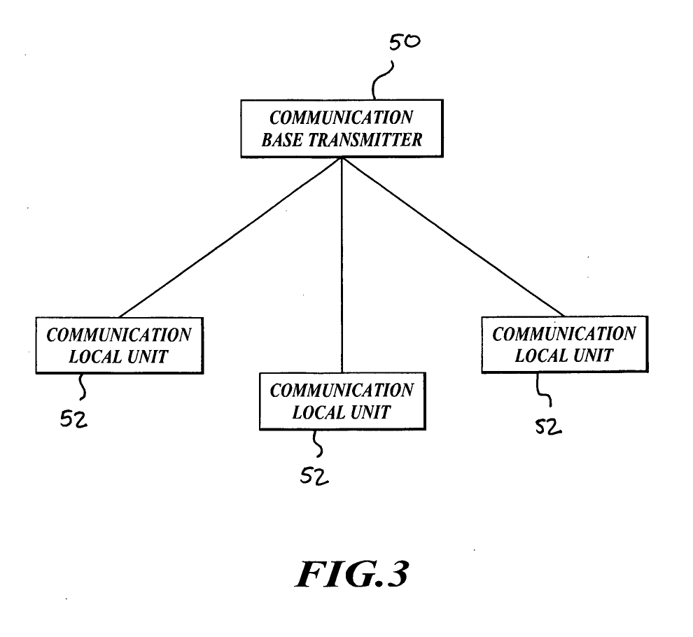

FIG. 3 is an overall block diagram of a suggested configuration for such a larger communication network/system. It is contemplated that this system may be appropriate for schools. In such an application, the base transmitter unit 50 could be located in the administration or principal's office, and one or more local receiving unit 52 comprising communication tool(s) with receiving functionality could be located in each classroom or other part of the school. Then in case of an emergency, when other communication routes are unavailable (e.g., power has been disconnected, or telephone lines have been disrupted), this system may form a communication lifeline for those trapped inside the classrooms. In an alternate situation, the base transmitter unit 50 may be located in a fleet administrator's office with the local units 52 located in each vehicle of the fleet.

Each local unit 52 comprises a communication cradle 10 with various windows and tabs (as shown in the previous figures) strategically placed to limit the local manipulation of the communications tool(s) therein. The windows 16 and tabs 26 can be configured to cover selected controls according to a predetermined use. For instance, the tabs can prevent a local user from turning the cell phone (or other communication tool) off, from adjusting the volume, or from ignoring calls. With this system, the principal or other administrator can rely on the integrity of the message being transmitted by the base unit and received locally.

What is claimed is:

1. A communication cradle comprising a first portion having a front generally planar panel and also having a perimeter edge, a second complementary portion having a back generally planar panel and also having a perimeter edge, the two said edges being formed to fit nestingly to one another to form a closed container for securing a communication tool with operative buttons thereof, said front panel defining a window, said front panel also defining at least one tab protruding into said window to cover at least one of said operative buttons preventing the use thereof.

2. The communication cradle of claim 1 further comprising a locking mechanism for locking said first portion to said second portion when the two portions have been nested together at their respective perimeter edges.

3. The communication cradle of claim 2 wherein said front panel defines two or more windows for revealing parts of the communication tools therein.

4. The communication cradle of claim 2 wherein said perimeter edges are spaced apart from said front and back planar panels by connecting walls so that the two portions define an interior cavity within the closed container.

5. The communication cradle of claim 4 wherein the communication tool is a cell phone.

6. The communication cradle of claim 5 wherein said back panel is formed to securely hold an amplifier unit in addition to said cell phone.

7. The communication cradle of claim 5 wherein said back panel is formed to securely hold a battery backup unit in addition to said cell phone.

8. The communication cradle of claim 5 wherein said back panel is formed to securely hold a speaker in addition to said cell phone.

9. The communication cradle of claim 4 wherein said window reveals only as much of said cell phone as is necessary according to a predetermined use.

10. The communication cradle of claim 9 wherein said tab protrudes into said window to cover an on/off switch so that the local user cannot turn the cell phone off.

11. The communication cradle of claim 9 wherein said tab protrudes into said window to cover a volume control so that the local user cannot adjust the volume of the cell phone.

12. A communication cradle comprising a container for holding a communication tool therein, said communication tool having receiving functionality, said container defining at least one window and at least one tab protruding into said window for covering selected controls on said communication tool, thereby limiting the manipulation of said communication tool by a local user.

13. The communication cradle of claim 12 wherein said container comprises two complementary locking portions which mate together to form an interior cavity for holding said communication tool.

14. The communication cradle of claim 13 wherein said at least one tab covers an on/off control of said communication tool.

15. The communication cradle of claim 13 wherein said at least one tab covers a volume control of said communication tool.

16. A communication system comprising a base transmitter and a plurality of local receiving units, each receiving unit being housed in a communication cradle designed to limit a local user's manipulation of said receiving unit.

17. The communication system of claim 16 wherein said receiving units are cell phones and said communication cradles prevent the manipulation of specified operative controls thereof.

18. The communication system of claim 17 wherein each of said communication cradles comprises two mating portions having locking means thereon to prevent opening by the local user.

19. The communication system of claim 18 wherein said specified controls are chosen from the group comprising on/off controls and volume controls.
